(19) United States
(12) Patent Application Publication
(10) Pub. No.: US 2019/0255499 A1
(43) Pub. Date: Aug. 22, 2019

(54) RADIAL MULTI-TUBULAR CATALYTIC REACTOR

(71) Applicant: IFP ENERGIES NOUVELLES, Rueil-Malmaison Cedex (FR)

(72) Inventors: Fabrice DELEAU, Balbigny (FR); Frederic BAZER-BACHI, Irigny (FR)

(73) Assignee: IFP Energies Nouvelles, Rueil-Malmaison Cedex (FR)

(21) Appl. No.: 16/308,083

(22) PCT Filed: Apr. 24, 2017
(86) PCT No.: PCT/EP2017/059673

§ 371 Date: Dec. 7, 2018

(30) Foreign Application Priority Data
Jun. 8, 2016 (FR) 1655251

(51) Int. Cl. B01J 8/02; B01J 8/08; B01J 8/12

(52) U.S. Cl. CPC B01J 8/0221; B01J 8/0278; B01J 2208/027; B01J 8/12; B01J 2208/00752; B01J 8/085

(57) ABSTRACT

A reactor (1) delimited by a shell (2) extending along a vertical axis:
a vessel provided with a reaction zone (10) containing a bed of catalyst;
at least one inlet (3) for a gaseous feed;
at least one outlet (4) for a gaseous effluent produced in the reaction zone (10),
   inside the reaction zone (10), at least two tubes extending substantially vertically over the height of the reaction zone, the tubes being permeable to a gas phase and impermeable to catalyst, each tube (9) having an upper end (11) in communication with the inlet for the feed or with the outlet means for an effluent and an opposed second end (12), the tubes (9, 24) supported at their upper end by a first plate (14) which is secured to the shell (2), via a connection assembly providing a pivot and slide type connection.

The present invention relates to the field of reactors for carrying out catalytic reactions and in which a radial circulation of the feed to be treated takes place from the periphery of the vessel towards the centre or from the centre of the vessel towards its periphery. In the context of the invention, the term “radial” is used for a flow of reagents occurring through a catalytic bed in a set of directions corresponding to radii orientated from the periphery of the reactor towards the centre of the reactor or from the centre towards the periphery of the reactor. The present invention is of particular application to a radial flow of a reagent in the gas form, and in particular for radial reactors in which the bed of catalyst is a moving bed.

### PRIOR ART

The most representative unit for this type of flow is a regenerative reforming unit for gasoline type hydrocarbon cuts which can be defined as having a distillation range in the range 80° C. to 250° C. Certain of these radial bed units, including regenerative reforming, use a flow of catalyst which is termed a moving bed, i.e. a slow gravitational flow of particles of catalyst confined in the annular vessel delimited by an outer screen and an inner wall (for example an inner screen) corresponding to the central collector, which recovers the reaction effluents.

The feed is generally introduced via the outer periphery of the annular bed and passes through the catalytic bed in a manner which is substantially perpendicular to the vertical direction of flow thereof. The reaction effluents are then recovered in the central collector.

The catalytic bed is thus delimited on the inside by an inner screen which acts as the central collector and on the outside either by another screen of the same type as the inner screen, or by a device consisting of an assembly of screen elements in the form of scallops.

The inner and outer screens are porous so as to allow the feed to pass through the annular catalytic bed from the outer screen side, and to allow reaction effluents to pass from the inner screen side into the central collector.

In order to satisfy the aim of optimizing the catalytic volume for the same reactor volume and that of facilitating the operations of repair and maintenance of such radial reactors, the Applicant has developed a novel type of radial reactor with a moving bed of catalyst, which is described in the document FR 2 948 580, in which the outer screen is replaced by a plurality of vertical distribution tubes immersed in the catalytic bed close to the wall of the reactor. An assembly of this type substantially improves the utilization rate of the unit while allowing for easy repair of the system in the case of damage; the repair then consists of simply replacing the damaged tube or tubes, thereby resulting in better operability of the process. This design for the reactor also contributes to better use of the catalytic volume. As described in FR 2 948 580, the tubular system can be used either as a system for distributing the feed, or for collecting the gaseous effluent produced by the catalytic reaction.

It has been observed that in such radial reactors with a tubular distribution and/or collection system, the tubes, which extend vertically over a height which is generally in the range 2 to 20 m, are subjected to high mechanical stresses (expansion and/or compression), in particular generated by the gravitational movement of catalyst (when the reactor has a moving bed of catalyst), which then exerts a frictional force on the tubes, and by temperature disparities in the reaction zone of the reactor (in operation, in a cooling situation, in a start-up/restart situation or in the case of an emergency shutdown). Such forces may, for example, be at the origin of the phenomenon of buckling of the tubes.

One aim of the present invention is to propose a radial reactor with a moving or fixed bed of catalyst for which the tubular system for distribution and/or collection of gaseous fluid is improved in terms of mechanical behaviour in the presence of forces exerted on the tubes, irrespective of the operating conditions of the reactor.

### SUMMARY OF THE INVENTION

The invention concerns a reactor delimited by a shell extending along a vertical axis, comprising:
a vessel provided with a reaction zone containing a bed of catalyst;
at least one inlet means for a gaseous feed;
at least one outlet means for a gaseous effluent produced in the reaction zone;
   the reactor comprising, inside the reaction zone:
at least two tubes extending substantially vertically over the height of the reaction zone, the tubes being permeable to a gas phase and impermeable to catalyst, each tube having an upper end in communication with the inlet means for the feed or with the outlet means for an effluent.

The tubes are supported at their upper end by a first plate which is secured to the shell, via a connection assembly providing a pivot and slide type connection.

Employing a connection means between the upper end of the tube and a plate which is secured to the shell, means that the forces exerted on the tube can be taken up and transmitted to the shell. Furthermore, because the connection is of the pivot and slide type, the tube is provided with two degrees of freedom of movement, in translation (sliding) and in rotation about the longitudinal axis (pivotal), meaning that the tube can respond better to expansional stresses (linked to thermal and/or frictional differentials) and contractional stresses (in particular thermal).

In one embodiment, the reactor comprises a fixed bed of catalyst.

In a preferred embodiment, the reactor in accordance with the invention is a radial reactor with a moving bed of catalyst of the sort which further comprises at least one inlet means for catalyst in order to introduce the catalyst into an upper portion of the reaction zone and at least one outlet means for catalyst discharging into the lower portion of the reaction zone.

Preferably, the connection assembly comprises a sleeve carried by the first plate and configured in order to receive a tube, and the tube and the sleeve respectively comprise a first and a second abutment means which cooperate with each other in a manner such as to limit the displacement of said tube in the sleeve in a vertical downwards direction. In one embodiment, the first abutment means is configured in a manner such as to bear on the upper free end of the sleeve. In accordance with another embodiment, the first abutment means is carried by the outer surface of the tube and the second abutment means is carried by the inner surface of the sleeve in a manner such as to come into abutment, one against the other, in a manner such as to limit the displacement of said tube in the sleeve in a vertical downwards direction. As an example, the abutment means may be a flange or a lug.

Advantageously, the lower end of the tubes is also supported either by the shell or by a second plate which is secured to the shell via a connection assembly which provides a pivot and slide type connection.

The reactor in accordance with the invention may further comprise at least one means for collecting a gaseous effluent disposed in the reaction zone, which is in communication with the outlet means for the gaseous effluent. Alternatively, the reactor may comprise at least one means for distributing the gaseous feed disposed in the reaction zone, which is in communication with the inlet means for the gaseous feed. As an example, the collection or distribution means is a central tube extending substantially vertically over the height of the reaction zone, which is permeable to a gaseous phase and impermeable to catalyst.

In accordance with another embodiment, the reactor comprises, as a means for collection or distribution of a gaseous fluid, a plurality of tubes which are permeable to a gas phase and impermeable to a catalyst which extend substantially vertically over the height of the reaction zone and in which the upper end of the tubes is supported by the first plate via a connection assembly which provides a pivot and slide type connection.

### DETAILED DESCRIPTION OF THE INVENTION

The other characteristics and advantages of the invention will become apparent from the following description, given solely by way of non-limiting illustration, and accompanied by:

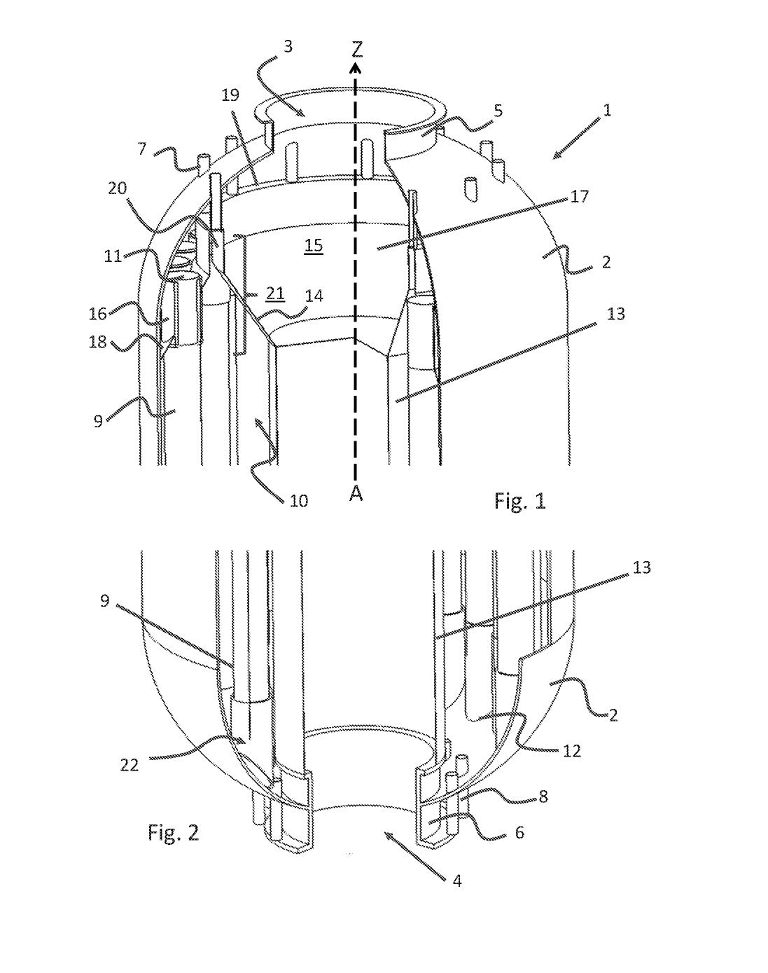

FIG. 1, which is a perspective view including a partial sectional view of the upper section of a radial moving bed reactor in accordance with the invention;

FIG. 2, which is a perspective view including a partial sectional view of the lower section of a radial moving bed reactor in accordance with the invention;

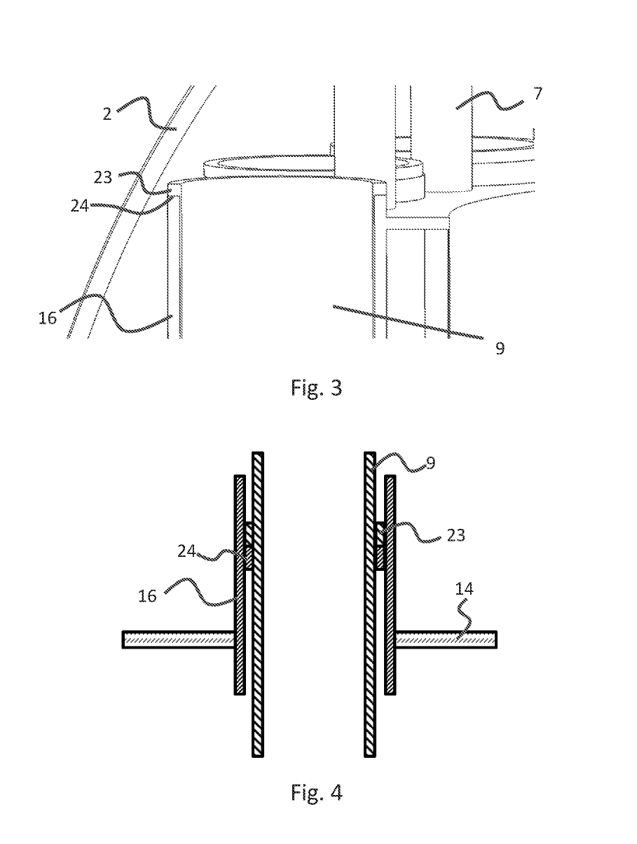

FIG. 3, which is a detailed view of a connection assembly used in a reactor in accordance with the invention;

FIG. 4, which is a sectional view of another embodiment of a connection assembly;

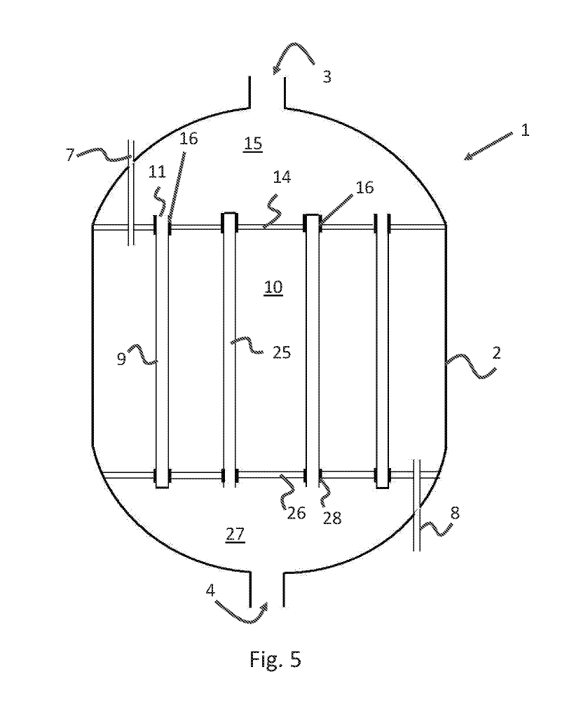

FIG. 5, which is a sectional view of a second embodiment of a reactor in accordance with the invention.

In general, identical elements are denoted by the same reference numerals in the figures.

A first embodiment of a radial moving bed reactor in accordance with the invention is described with reference to FIGS. 1 and 2. However, it should be noted that the reactor in accordance with the invention may also be a radial reactor with a fixed bed of catalyst.

The catalytic radial flow reactor 1 in accordance with the invention, which is in the shape of a carboy formed by a shell 2, delimits a cylindrical vessel which extends along a substantially vertical axis of symmetry (AZ).

The upper portion of the shell 2 comprises a first orifice 3 and its lower portion comprises a second orifice 4 which are respectively the inlet means for the feed to be treated and the outlet means for the effluents produced by the catalytic reaction. It is also possible to use the first orifice 3 as the outlet means for the effluent and the second orifice 4 as the inlet means for the feed. The shell 2 delimits a vessel which contains a reaction zone 10.

The first and second orifices 3, 4 located respectively above and below the reaction zone 10 are surrounded by a tube 5, 6 which can thus be used to connect the shell to a fluid inlet and outlet pipework system.

As indicated in FIG. 1, a plurality of tubes 7 (also known as legs) for introducing catalyst which discharge into the upper portion of the vessel and into the reaction zone 10 pass through the upper portion of the shell 2. The shell also comprises a plurality of tubes 8 for evacuating (or withdrawing) catalyst disposed in the lower portion of the vessel. The catalyst evacuation (or withdrawal) tubes 8 extend down into the bottom of the reaction zone 10 and discharge outside the reactor 1. The catalyst which is distributed in the reaction zone 10 is in the form of particles, for example spherical particles with a diameter which is generally in the range 1 to 5 mm. Clearly, the catalyst may take other forms such as, for example a simple cylindrical granule, or be multilobed in shape, for example trilobed or quadrilobed. When the reactor is in operation, the catalyst introduced through the top of the reactor via the legs 7 flows under gravity in the reaction zone 10 and is evacuated via the legs 8.

In accordance with the present invention, the reactor 1 comprises a plurality of tubes 9 which are immersed in the reaction zone 10. The tubes 9 extend in the reaction zone 10 in a substantially vertical direction, preferably substantially parallel to the axis of symmetry AZ, and over at least 80% of the height of the reaction zone 10. The function of the tubes 9 is to allow either the introduction of feed (the tube is then termed a feed distribution tube), or the collection of reaction effluent (the tube is then termed a collector tube). The tubes 9 are designed in a manner such as to be permeable to a gaseous fluid and impermeable to catalyst. The tubes 9 may, for example, be in the form of a tube provided with openings with a dimension that is smaller than the size of the particles of catalyst, or in fact in the form of a “Johnson” type screen known to the person skilled in the art. The tubes 9 are preferably circular in cross section. However, the cross section of the tubes may take different forms, for example rectangular or square.

Referring now to FIG. 1, inside the reaction zone 10, the reactor also comprises a cylindrical central zone delimited by a tube 13 which is permeable to a gaseous fluid and impermeable to catalyst. The central tube extends in a substantially vertical direction, preferably substantially parallel to the axis of symmetry (AZ) over at least 80% of the height of the reaction zone 10. The role of the central tube 13 is either to allow collection of the effluent, or to allow distribution of the feed, depending on the role played by the tubes 9. Thus, when the tubes 9 are used to distribute the feed, the central tube 13 acts as an effluent collector tube. In contrast, when the tubes 9 are used to collect reaction effluent, the central tube 13 is a tube for distributing the feed.

In accordance with a first functional embodiment in which the tubes 9 are used as distribution means for the feed which is introduced via the upper orifice 3 of the shell and in which the central tube is employed as a collector tube for the gaseous effluent, the upper first end 11 of the tubes 9 is open in order to communicate with the orifice 3, while their lower second end 12 is closed so as to prevent the passage of gaseous feed via said second end. In this case too, the upper end of the central tube 13 is closed, while the lower end is open in order to communicate with the orifice 4 disposed in the bottom of the reactor so that the gaseous effluent can be evacuated.

In a second functional embodiment in which the tubes 9 are used as the collection means for the gaseous effluent and the central tube 13 acts as a distribution means for the feed and in which the feed is introduced via the bottom of the reactor via the orifice 4 and the effluent is withdrawn from the reactor via the upper orifice 3, the lower end of the tubes 9 and the upper end of the central tube 13 are closed.

In a third functional embodiment in which the tubes 9 are used as a distribution means for the feed and the central tube 13 acts as a collection means for the gaseous effluent and in which the feed is introduced through the bottom of the reactor via the orifice 4 and the effluent is withdrawn from the reactor through the upper orifice 3, the upper end of the tubes 9 and the lower end of the central tube 13 are closed.

In accordance with a fourth functional embodiment, the tubes 9 act as collection means for gaseous effluent, the central tube 3 is used as a distribution means for the gaseous feed and the feed is introduced via the upper orifice 3 and the effluent is evacuated from the reactor via the lower orifice 4. In this case, the upper end of the tubes 9 and the lower end of the central tube are closed.

With reference to FIG. 1, it can be seen that in its upper portion, the reactor is equipped with a plate 14 which is secured to the shell 2 in a manner such as to define a zone 15 for confining a gaseous fluid, either the gaseous feed or the gaseous effluent, above the reaction zone 10. The upper plate 14 is impervious to particles of catalyst and to gas moving in the confinement zone 15 and in the reaction zone 10.

In this embodiment, the legs 7 for introducing catalyst are supported by the upper plate 14 and are arranged in a manner such that their free open end discharges into the upper portion of the reaction zone 10 located below the upper plate 14. In accordance with the invention, the tubes 9 (for distribution of the feed or for collection of the effluent) are supported by the upper plate 14 and pass through it in a manner such that their upper end 11 discharges above the upper plate, in the confinement zone 15 for a gaseous fluid. In accordance with the invention, the tubes 9 are supported at their upper ends by the plate 14, by means of a connection assembly which provides a pivot and slide type connection which is described in detail below.

With reference to FIG. 1, it will be noted that the upper plate 14 comprises a portion which is in the form of an inverted truncated cone 17 (i.e. the apex of the cone is directed towards the bottom of the reactor), wherein the circular base has a diameter which is smaller than that of the vessel, and a circular skirt 18 which provides the connection of the tapered portion 17 to the shell 2. The circular skirt 18 has an inclination which falls in the direction of the bottom of the reactor 1. It will also be observed that the base of the cone is connected to the circular skirt 18 by means of an annular flat surface 19 which supports the tubes 7 for distribution of the catalyst. In the embodiment shown in FIG. 1, the skirt 18 is extended by an annular portion 20 extending along the vertical axis, which is connected to the flat surface 19. Thus, the upper plate comprises a portion 21 in the form of a funnel. The catalyst which is introduced via the distribution legs 7 passes into the annular cylindrical portion 20, then is dispersed into the second tapered annular zone 21 of the funnel. Alternatively, the skirt 18 of the plate 14 could be connected directly to the flat surface 19. These embodiments of the upper plate 14 with conical sections have the advantage of improving the dispersion of the catalyst and avoiding the formation of a sloping surface, thereby limiting the formation of pockets of gas in the reaction section.

In the context of the invention and alternatively, the skirt 18 could extend in an essentially horizontal plane, i.e. perpendicular to the vertical axis (AZ).

Clearly, the upper plate 14 could be configured differently such as, for example, as indicated in FIG. 5, as a disk which comprises orifices through which the distribution tubes 7 for the catalyst and the feed distribution tubes or effluent collector tubes 9 pass.

FIG. 2 represents a preferred embodiment of the reactor, in which the lower end of the tube 9 (for distribution of feed or for collection of effluent) is also connected to the shell 2 via a connection assembly 22 providing a pivot and slide type connection including a connection means mounted directly on the shell 2. Alternatively, the connection means cooperating with the lower end of the tubes could be supported by a lower plate which is secured to the shell and disposed in the lower section of the reactor (see FIG. 5).

The pivot and slide type connection assembly providing the connection between a tube 9 (for distribution or collection) and the upper plate 14 is detailed in FIGS. 3 and 4. The function of the connection assembly is to axially support the tube 9 and also to allow the forces exerted on the tube 9 by the catalyst as it is displaced under gravity to be taken up.

In accordance with the invention, the connection assembly presents the tube 9 with two degrees of freedom, namely in translation along the vertical axis of the tube and in rotation about the vertical axis of the tube.

The connection assembly comprises a sleeve 16 fixed to the upper plate 14, which has an internal diameter (or section) which is larger than the external diameter (or section) of the tube 9 in a manner such that the tube 9 is capable of sliding inside the sleeve 16. The connection assembly also comprises a first abutment means 23 and a second abutment means 24 respectively carried by the tube 9 and the sleeve 16, the first and second abutment means cooperating with each other in a manner such as to limit the displacement of the tube in the sleeve in a downwards vertical direction. In accordance with the invention, the sleeves 16 passing through the plate 14 may be secured to said upper plate by screwing or welding.

In the embodiment of FIG. 3, at its upper free end, the tube 9 carries a circular flange (or collar) 23 which is capable of abutting against the upper free end 24 of the sleeve 16 in a manner such as to limit the displacement of the tube 9 in the sleeve 16 in a vertical downwards direction substantially parallel to the axis (AZ).

FIG. 4 describes another embodiment of the pivot and slide connection assembly in which the first abutment means 23 is carried by the outer surface of the tube 9 and the second abutment means 24 is carried by the inner surface of the sleeve 16.

The tubes 9 have a distribution or collection sector (or window) with an angle α which is generally in the range 30° to 360°, and preferably in the range 30° to 180°. In the case in which the distribution or collection sector is not open over the entire circumference of the tube (i.e. where the angle α is equal to 360°), indexing means may be provided between the tube and the sleeve in order to orientate the sector within the reaction zone 10.

Another embodiment of the reactor 1 in accordance with the invention is shown in a diagrammatic manner in FIG. 5. This embodiment differs from that of FIG. 1 by the absence of a central tube 13 which is replaced by a plurality of vertical tubes 25 that extend in the reaction section 10 of the reactor. Referring to FIG. 5, the vertical tubes 25 pass through the upper plate 14 in a manner such that their upper end opens into the zone 15 for confining a gaseous fluid. The vertical tubes 25 are also connected to the upper plate 14 via a connection assembly which is identical to that used for the tubes 9. Thus, the connection assembly comprises a sleeve 16 which is secured to the upper plate 14, and which is capable of receiving the tube 25. The tube 25 and the sleeve 16 also comprise abutment means cooperating with each other in order to limit the displacement of the tube 25 in a vertical downwards direction. The reactor of FIG. 5 is also equipped with a lower plate 26 which is secured to the shell 2 which supports the vertical tubes 9 and 24 at their lower end. The lower plate 26 is impervious to catalyst and impermeable to gas. More precisely, the lower section of the tubes 9 and 25 passes through the lower plate 25 in a manner such that their lower end discharges below said plate in a confinement zone 27 for a gaseous fluid (the feed or the effluent).

Preferably, the lower end of the tubes 9 and 25 is connected to the lower plate 26 via a pivot and slide connection assembly, by means of a sleeve 28 which can receive the lower free end of tubes 9 and 25. Optionally, the sleeve 28 may comprise abutment means which cooperate with the abutment means carried by the tubes 9, 25 in a manner such as to limit vertical displacement of the tubes. These lower connection means provide a supplemental take-up for forces in order to prevent said lower end of the tubes from bearing directly on the catalytic bed and to ensure that the axial position in the reaction zone is stable. In this embodiment, for example, the tubes 9 carry out the function of distribution of the gaseous feed, while the tubes 25 carry out the function of collection of the gaseous effluent. It should be noted that in this embodiment, all of the tubes are open at one end and closed at the other, opposite, end. As an example, when the feed is introduced via the upper orifice 3 of the reactor and the effluent is withdrawn from the bottom of the reactor via the orifice, the tubes said to be for “distribution” of the feed are open at their upper end and closed at their lower end, while the tubes said to be for “collection” of the effluent are open at their lower end and closed at their upper end. Conversely, when the gaseous feed is introduced through the bottom of the reactor via the orifice 4 and the reaction effluent is withdrawn through the upper orifice 3, the tubes said to be for “distribution” of the feed are open at their lower end and closed at their upper end, while the tubes said to be for “collection” of the effluent are open at their upper end and closed at their lower end.

By way of example, the principle of operation of a reactor with a moving bed of catalyst in accordance with the invention will now be described with reference to FIG. 5 and in a functional embodiment in which the gaseous feed is sent to the head of the reactor and the effluent is collected from the bottom of the reactor.

The gaseous hydrocarbon feed is sent to the reactor 1 through the upper orifice 3 and fills the confinement volume 15 delimited by the shell and the upper plate 14. The feed is supplied to the reaction zone 10 by means of vertical distribution tubes 9 via the upper opening 11 discharging into the confinement zone 15. The feed moves in the distribution tubes 9 and diffuses radially through the distribution tubes, which are permeable to gaseous fluid and impermeable to particles of catalyst, into the reaction zone 10.

Regarding the catalyst, this is sent continuously to the reaction zone 10 via the catalyst distribution tubes (or legs) 7 the free end of which discharges into the reaction zone 10, under gravity at a relatively slow rate (of the order of one metre per hour). The catalyst then fills the reaction zone 10 and is also continuously withdrawn from the reaction zone 10 and evacuated from the reactor via the catalyst outlet tubes (or legs) 8. The catalyst, which is then uniformly distributed so as to occupy the volume of the reaction zone 10, comes into contact with the gaseous feed in order to carry out the catalytic conversion reaction and produces a reaction effluent. The reaction effluent is collected via the effluent collector tubes 25 which are permeable to the reaction effluent and impermeable to catalyst. The effluent diffuses radially in the effluent collector tubes 25 and is fed to the effluent confinement space 27 located below the lower plate 26. The effluent is evacuated from the reactor via the effluent outlet orifice 4 which is in communication with the effluent confinement space 27.

Using a pivot and slide connection assembly in a multi-tube reactor with a moving bed of catalyst means that buckling phenomena in the tube can be limited when it is placed under a compressive load. Furthermore, given that the tube is capable of being displaced along its vertical axis, it is also less sensitive to thermal expansion phenomena which may lead to compression of the catalyst present below the tube and to the generation of fines.

Using a pivot and slide connection assembly placed at the upper and lower ends of the tube guarantees that the tube will be properly retained vertically in the reaction section, even in the case in which the flow of catalyst in said reaction section is not uniform. A displacement of the tube by tilting should be avoided in this reaction section, so that the trajectories of the fluids are not modified and thus that the dwell times are uniform throughout the reaction section.

Employing a sleeve system associated with abutment means signifies that the use of a permanent fixing system, for example by welding the tube to the plate, can be dispensed with, and thus replacement of a defective tube is facilitated.

1. A reactor (1) delimited by a shell (2) extending along a vertical axis, comprising:
a vessel provided with a reaction zone (10) containing a bed of catalyst;
at least one inlet means (3) for a gaseous feed;
at least one outlet means (4) for a gaseous effluent produced in the reaction zone (10);
the reactor comprising, inside the reaction zone (10):
at least two tubes extending substantially vertically over the height of the reaction zone, the tubes being permeable to a gas phase and impermeable to catalyst, each tube (9) having an upper end (11) in communication with the inlet means for the feed or with the outlet means for an effluent and an opposed second end (12),
characterized in that the tubes (9, 24) are supported at their upper end by a first plate (14) which is secured to the shell (2), via a connection assembly providing a pivot and slide type connection.

2. The reactor as claimed in claim 1, in which the bed of catalyst is a fixed bed.

3. The reactor as claimed in claim 1, in which the bed of catalyst is a moving bed and the reactor further comprises:
at least one inlet means (7) for catalyst in order to introduce the catalyst into the upper portion of the reaction zone (10);
at least one outlet means (8) for catalyst discharging into the lower portion of the reaction zone (10).

4. The reactor as claimed in claim 1, in which the connection assembly comprises a sleeve (16) carried by the first plate (14) and configured in order to receive a tube (9), and in which the tube and the sleeve respectively comprise a first and a second abutment means (23, 24), the first and second abutment means (23, 24) cooperating with each other in a manner such as to limit the displacement of said tube in the sleeve in a vertical downwards direction.

5. The reactor as claimed in claim 4, in which the first abutment means (23) is configured in a manner such as to bear on the upper free end of the sleeve (14).

6. The reactor as claimed in claim 4, in which the first abutment means (23) is carried by the outer surface of the tube and the second abutment means (24) is carried by the inner surface of the sleeve (16).

7. The reactor as claimed in claim 3, in which the abutment means is a flange or a lug.

8. The reactor as claimed in claim 1, in which the lower end (12) of the tubes (9, 24) is supported either by the shell (2) or by a second plate (25) which is secured to the shell via a connection assembly (27) which provides a pivot and slide type connection.

9. The reactor as claimed in claim 1, further comprising at least one means (13) for collecting a gaseous effluent disposed in the reaction zone (10) and which is in communication with the outlet means (4) for the gaseous effluent.

10. The reactor as claimed in claim 1, comprising at least one means (13) for distributing the gaseous feed disposed in the reaction zone (10) and which is in communication with the inlet means for the gaseous feed.

11. The reactor as claimed in claim 9, in which the collection or distribution means (13) is a central tube extending substantially vertically over the height of the reaction zone (10), the central tube being permeable to a gaseous phase and impermeable to catalyst.

12. The reactor as claimed in claim 9, in which the collection or distribution means (13) comprises a plurality of tubes (9, 24) which are permeable to a gas phase and impermeable to catalyst, which extend substantially vertically over the height of the reaction zone and in which the upper end (11) of the tubes is supported by the first plate (14) via a connection assembly which provides a pivot and slide type connection.
